(19) United States
(12) Patent Application Publication
(10) Pub. No.: US 2002/0174087 A1
(43) Pub. Date: Nov. 21, 2002

(54) Method and system for web-based visualization of directed association and frequent item sets in large volumes of transaction data

(76) Inventors: Ming C. Hao, Palo Alto, CA (US); Umeshwar Dayal, Sratoga, CA (US); Meichun Hsu, Los Altos Hills, CA (US); Markus Gross, Uster (CH); Thomas Sprenger, Rorschacherberg (CH)

Correspondence Address: HEWLETT-PACKARD COMPANY, Intellectual Property Administration, P.O. Box 272400, Fort Collins, CO, 80527-2400, US

(21) Appl. No.: 09/847,390

(22) Filed: May 2, 2001

(51) Int. Cl. G06F 7/00

(52) U.S. Cl. 707/1

(57) ABSTRACT

A directed association visualization (DAV) method and system provides a visualization tool for mining large volumes of transaction data to extract marketing and sales information generated by applications, such as real-world electronic commerce (E-commerce) applications. The DAV mechanism visually associates data items, affinities, and relationships for large-volume data (e.g., e-commerce transaction data). Furthermore, the DAV mechanism maps data items and their relationships to vertices, edges, and positions in visual three-dimensional space. The distance between a pair of items represents the frequency of the item set in the transaction data, and the directed edge represents the association confidence levels and association directions between the items in the transaction data. The DAV mechanism also encapsulates a physics-based system to position data items in a three dimensional space. Items that have a high correlation are positioned close to each other.

### FIELD OF THE INVENTION

The present invention is generally related to visual data mining, and in particular, to a method and system for web-based visualization of directed association and frequent item sets in large volumes of transaction data (e.g., real-time transaction data).

### BACKGROUND OF THE INVENTION

With the advent of the Internet and the World Wide Web (WWW), there is an ever-increasing number of electronic stores that offer a wide variety of products and services. For example, there are electronic stores selling everything from groceries to computer peripherals. These electronic transactions (e.g., purchase and sale transactions) contribute to what is commonly referred to as electronic commerce or E-commerce. As can be appreciated, a single web site can have many customers over the course of hours, days, and weeks. In fact, a challenge is how to use the huge volume of transaction data to derive useful information that can provide a useful business purpose.

One such business purpose is to determine what products customers typically purchase together. This form of analysis is commonly referred to as market basket analysis. Market basket analysis is useful in many different business decisions, such as product recommendations for customers, promotions, cross-selling, and store shelf arrangements. For example, based on market basket information, a merchant can then recommend to future customers, who purchase a particular product, one or more associated products that may be of interest to the customers, thereby increasing sales and profitability of the e-commerce business. Consequently, market basket analysis has become an important key to achieve and maintain a successful e-commerce business.

For example, a typical E-commerce transaction includes several products or items that are purchased together. Understanding these relationships across hundreds of product lines and among millions of transactions provides visibility and predictability into product affinity purchasing behavior. An example of an association is that 85% of the people who buy a printer also buy paper.

Effective market basket analysis methods employ techniques, such as association, to analyze the data. Association is one of the most effective methods for dealing with large E-commerce transaction data. An association rule is of the form X→Y, where X and Y are sets of items. X is known the antecedent, and Y is known the consequence of the rule. The strength of a rule is expressed by two factors: 1) support and 2) confidence.

The support of rule X→Y is the frequency of occurrence of X∪Y in all transactions (i.e. the support of X∪Y is defined as the ratio of the number of transactions in which X and Y occurs to the total number of transactions). The confidence of rule X→Y is the probability that if a transaction contains the antecedent, then it also contains the consequent (i.e., the ratio of the number of transactions that contain X∪Y to the number of transactions that contain X). Thus, if 85% of the customers who bought printer also bought paper, and only 10% of all the customers bought both, then the association rule has confidence 85% and support 10%. It is noted that the association direction is from the printer to the paper.

Unfortunately, the problem of how to use customer purchase history to find products that are usually sold together and to make suggestions to shoppers is not trivial and presents a formidable challenge. One approach to tackling this problem is to provide visualization tools that display the data as a real time graphic representation, which may be easier for a user to review, evaluate, and draw conclusion therefrom.

Currently, there are many technologies that allow the visualization of associations for retail stores to make business decisions. Unfortunately, current visualization tools are not suited for allowing a user to visually mine customer's purchasing behavior from large volumes of Internet transactions.

A common technique for visualizing associations is to use a matrix display or technique. The matrix technique positions pairs of items (antecedent and consequence) on separate axes to visualize the strength of their relationships. One publication that describes an example of a prior art 2-D Visualization Approach is, “Visualizing Association Rules for Text Mining”, by Pak Chung Wong, Paul Whitney, Jim Thomas, IEEE Info Vis99, CA.

There are also several commercially available products related to visual data mining technology that use the matrix technique. Two examples of such products are the Intelligent Miner that is available from IBM Almaden Research Center of San Jose, Calif., and MineSet that is available from Silicon Graphics, Inc. (SGI) of Mountain View, Calif. The MineSet and Intelligent Miner products display association rules on a three dimensional grid landscape, which is referred to as a matrix technique. Unfortunately, this approach is not suited for visualizing E-commerce transaction data that can have millions of transactions. Consequently, the matrix technique is too small and restrictive for the amount of transactions generated by E-commerce, thereby making it difficult if not impossible to effectively analyze the data.

Other visualization techniques lay out associations on a graph. For example, LikeMinds Partner Program available from Macromedia, Inc. of San Francisco, Calif. uses an individual purchase history to make suggestions to shoppers based on a directed graph. However, when the number of items grows large, the graph can quickly become cluttered with many interactions. Also, associated items may not be placed close together.

However, as the volume of e-commerce transaction data grows, and as online transaction data is integrated into off-line data, new data visualization associations are required to extract useful and relevant information. In particular, it would be desirable for a visualization mechanism that (1) visually indicates the closeness of relationships between items that co-occur in transactions to represent support; (2) visually indicates association directions and confidence levels; and (3) automatically generates self-organizing clusters of related items.

One disadvantage of the prior art visualization techniques is that graphic information fails to show the relationships among items in the transaction data. For example, in prior art visualization techniques, items with high correlation are not positioned close to each other. In the example of market basket analysis, milk needs to be placed next to bread in a graph to indicate that people likely buy milk and bread together in the same market basket.

A second disadvantage of the prior art visualization techniques is that the graphic information needs to show item association directions and confidence levels. In the above example, an association rule that states “85% of the people who buy a printer also buy paper,” does not imply that 85% people buy paper also buy a printer. Consequently, it is desirable to have a mechanism to provide a visual indication of confidence levels and directions.

Based on the foregoing, a significant need remains for system and method for visually associating product affinities and relationships for large-volume e-commerce transaction data that overcomes the disadvantages set forth previously.

### SUMMARY OF THE INVENTION

One aspect of the present invention is the provision of a directed association visualization (DAV) mechanism for indicating the closeness of relationships between items that co-occur in transactions to represent support.

Another aspect of the present invention is the provision of a directed association visualization (DAV) mechanism for indicating association directions and confidence levels.

Another aspect of the present invention is the provision of a directed association visualization (DAV) mechanism for extracting useful and relevant information from a large volume of data (e.g., real-time electronic commerce (E-commerce) transaction data).

Another aspect of the present invention is the provision of a directed association visualization (DAV) mechanism for extracting useful and relevant information from both online transaction data, off-line data, and online data integrated with off-line data.

Another aspect of the present invention is that the DAV mechanism positions items according to their association in order to show the strength of their relationships.

Yet, another aspect of the present invention is that the DAV mechanism represents the implication directions by employing edges with arrows

Yet, another aspect of the present invention is that the DAV mechanism integrates or encapsulates a mass-spring engine into a visual data-mining platform that provides a self-organized graph.

According to one embodiment, the directed association visualization (DAV) method and system of the present invention provides a visualization tool for mining large volumes of transaction data to extract marketing and sales information generated by applications, such as real-world electronic commerce (E-commerce) applications. The DAV mechanism of the present invention visually associates product affinities and relationships for large-volume data (e.g., e-commerce transaction data). Furthermore, the DAV mechanism of the present invention maps transaction data items and their relationships to vertices, edges, and positions on a visual spherical surface.

According to another embodiment, each item is extracted from the transaction data and mapped to a vertex. A frequency matrix is constructed based on the transaction data. The frequency matrix is used to map the association frequency to the distance between items. A direction matrix is also constructed based on the transaction data. The direction matrix is used to map the association confidence to the color of the edge between items and to map the association direction to the arrow of the edge. The vertices that each has a color and the edges for connecting the vertices, where each edge has a distance, color, and direction, are displayed in three dimensional (3D) space.

### BRIEF DESCRIPTION OF THE DRAWINGS

The present invention is illustrated by way of example, and not by way of limitation, in the figures of the accompanying drawings and in which like reference numerals refer to similar elements.

FIG. 1 illustrates an exemplary computer system in which the directed association visualization program can be implemented.

FIG. 2 illustrates an exemplary distributed client-server computer system in which the directed association visualization program can be implemented

FIG. 3 is a block diagram illustrating a directed association visualization (DAV) component architecture in accordance with one embodiment of the present invention.

FIG. 4 is a block diagram illustrating in greater detail the primary components of directed association visualization program in accordance with one embodiment of the present invention.

FIG. 5 is a flow chart illustrating the steps performed by the directed association visualization program of FIG. 4 in accordance with one embodiment of the present invention.

FIG. 6 illustrates an exemplary display generated by the directed association visualization program of FIG. 4.

### DETAILED DESCRIPTION OF THE PREFERRED EMBODIMENT

A directed association visualization (DAV) method and system that provides a visualization tool for mining large volumes of transaction data to facilitate the extraction of marketing and sales information are described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

System 10

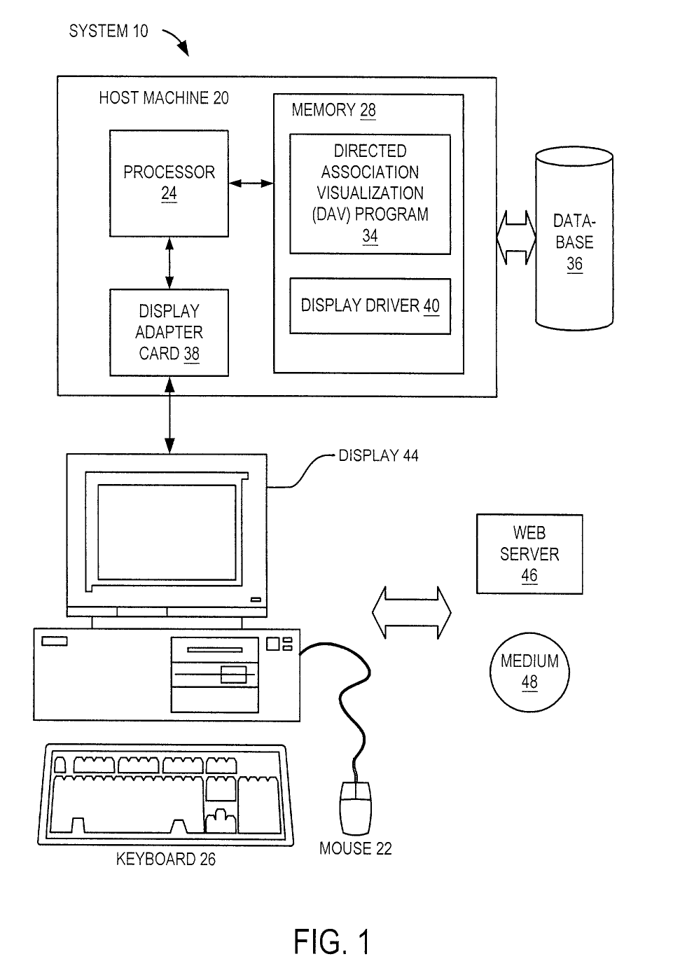

An exemplary system 10 in which the directed association visualization program 34 can be implemented is illustrated in FIG. 1. The system 10 includes a host machine 20, which can, for example, be a personal computer (PC). The host machine 20 has a processor 24 for executing computer programs, a memory 28 for storing programs and data, and a display adapter card 38 for controlling a display 44. The memory 28 includes the directed association visualization (DAV) program 34 of the present invention and a display driver 40 for use by the display adapter card 38 to communicate with the display 44.

The DAV program, when executing on the processor 24, maps transaction data items and their relationships to vertices, edges, and positions on a visual spherical surface. Consequently, the present invention provides a visualization tool that may be employed by a user to visualize internal relationships and implications between large volumes of transaction data.

For example, the DAV mechanism employs a sphere layout to place the most tightly related item in the center and all other items around the center. The most tightly related item is the item with the highest correlation with other items. By encapsulating a physics-based mass spring visualization system that is described in greater detail hereinafter, the DAV also generates a self-organized graph, where the distance between each pair of items represents support, a directed edge represents the direction of the association, and the color of the edge is used to represent the confidence level. The DAV mechanism may also employ an ellipsoidal surface to wrap clusters of highly related items. The DAV mechanism of the present invention is described in greater detail hereinafter.

A database 36 can be provided for supplying data and information (e.g., E-commerce transaction data). A keyboard 26 and a mouse 22 are provided for allowing a user to enter information to the PC. It is noted that the directed association visualization (DAV) program 34 of the present invention can be embodied in a computer readable medium (e.g., computer readable medium 48) that can, for example, be a compact disc or a floppy disk. It is further noted that the directed association visualization (DAV) program 34 of the present invention can reside and execute on a web server 46 that is remote from the host machine 20.

Exemplary Distributed Client-Server Computer System 60

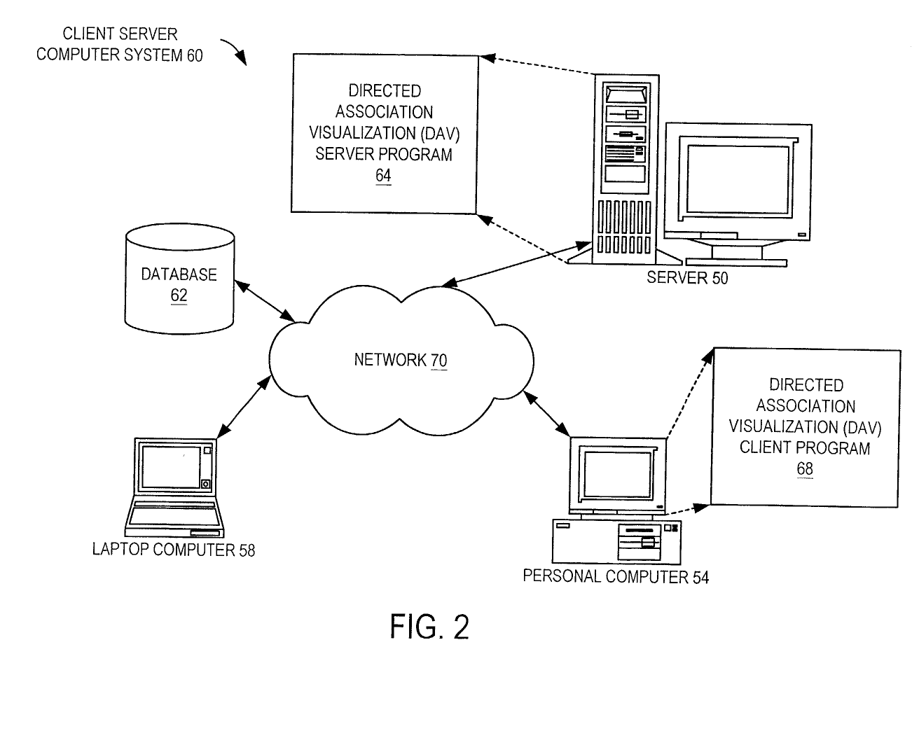

FIG. 2 illustrates an exemplary distributed client-server computer system 60 in which the directed association visualization program can be implemented. The computer system 60 includes a network 70 for connecting different devices (e.g., server computer 50, personal computer 54, laptop computer 58, and database 62. In this embodiment, the DAV program of the present invention includes a DAV server program 64 and a DAV client program 68. The DAV server program 64 can execute on a server (e.g., server 50), and the DAV client program 68 can execute on a client device, such as PC 54 or laptop computer 58. A database 62, which can be remote from both server 50 and client devices (54, 58), stores information and data (e.g., web transaction data) that requires analysis.

Exemplary DAV Component Architecture 128

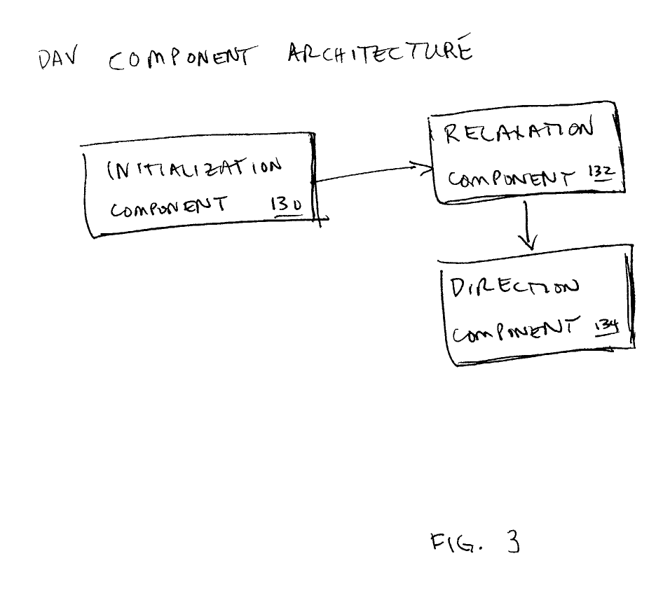

FIG. 3 is a block diagram illustrating a directed association visualization (DAV) component architecture 128 in accordance with one embodiment of the present invention. The architecture 128 includes an initialization component 130 for arranging items that are extracted from transaction data (e.g., E-commerce transaction data) to initial position on a spherical surface. The architecture 128 includes a relaxation component 132 for constructing a frequency matrix that defines the stiffness of a spring attached to a pair of items and for transforming the spring stiffness to a distance between the items after relaxation. The architecture 128 also includes a direction component for constructing a confidence matrix with confidence levels and for joining an antecedent of an association rule with the consequence by using a directed edge (e.g., an arrow). These components 130, 132, 134 and their operation are described in greater detail hereinafter.

DAV Mechanism 100

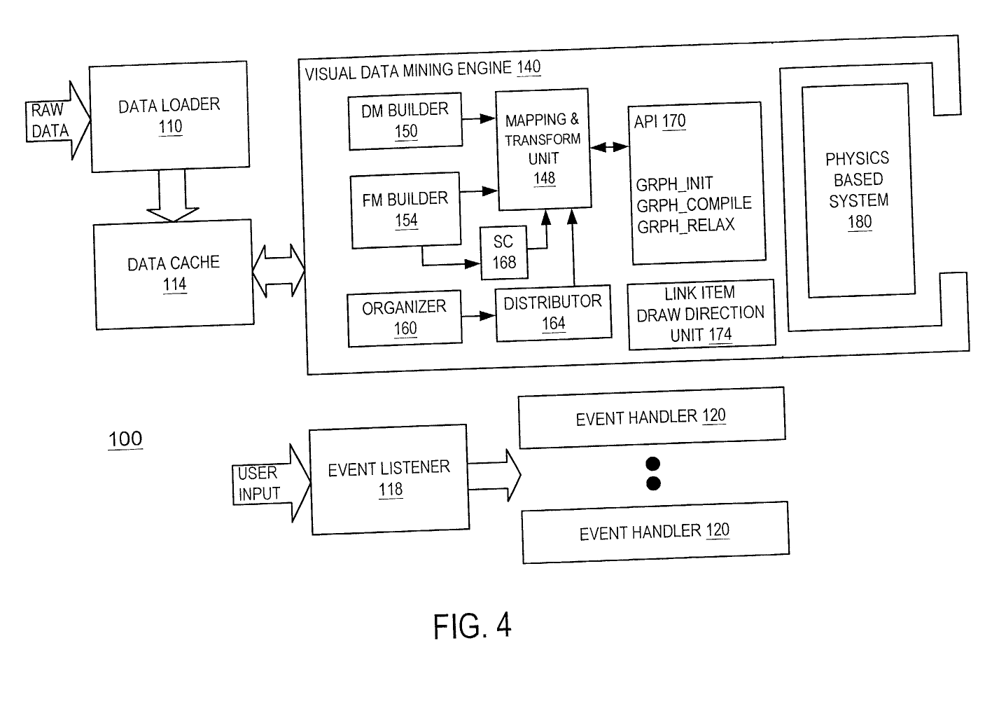

FIG. 4 illustrates the DAV mechanism 100 configured according to one embodiment of the present invention. The DAV mechanism 100 includes a data loader program 110 that when executing on a processor loads raw data into a data cache 114. The raw data can be transaction data from an electronic store. In one embodiment, the transaction data includes a list of transactions where each transaction includes one or more items (e.g., products). The data cache 114 can be a memory, such as a random access memory (RAM).

An event listener program 118 is provided for listening for user input (e.g., a mouse click). For example, when executing on the processor, the event listener program 118 receives user input (e.g., a signal from a cursor point device) and based thereon calls an appropriate event handler program 120 for performing an action corresponding to the user input. One example of an event handler 120 is an Item_Detail event handler that displays the details of the item (e.g., item name, item department, and item code number) for the user when a user clicks on an item on the graph. Another example is a relaxation event handler that relaxes the layout of the graph.

The system 100 includes a visual data mining engine (VDME) 140 for retrieving the raw data from the data cache 114, transforming the raw data into displayable data and displaying directed associations and frequencies of the data. An exemplary architecture of the VDME 140 is described in greater detail hereinafter.

One aspect of the present invention is the encapsulation of a physics-based mass-spring system 180 that is a generally well-known graphing technique into a visual data mining platform 140. As described in greater detail hereinafter, a set of programming interfaces 170 (APIs) are provided to interface with the physics-based system. One such physics-based mass-spring system is described by M. H. Gross, T. C. Spenger, J. Finger in a publication entitled, “Visualizing Information on a Sphere”, IEEE VisInfo97, which is incorporated by reference herein.

Preferably, a physics-based Mass-Spring system is encapsulated into the VDME 140 through the use of a set of programming interfaces 170 (APIs) that are provided by the present invention. The APIs can include GRPH_INIT, GRPH_COMPILE, and GRPH_RELAX. The physics-based mass-spring system 180 receives as an input a graph having a plurality of items in an initial position and based thereon after relaxation generates a self-organized graph that has converged to a state of local minimal energy.

The organizer 160 sorts the items based on how frequently items appear in the list of transactions. The results of the organizer 160 can be used to map each vertices (each vertex representing an item) to a particular color. For example, one color can be used to represent items that frequently appear in transactions, and a second color can be used to represent items that appear very infrequently in transactions. The varying shades of colors between the first color and the second color can represent the varying degrees of differences in the frequency of appearance.

During initialization, DAV uses a sphere layout to place the most tightly related item in the center and all other items around the center. For example, the distributor 164 places all items evenly in a distributed 3-D spherical surface. A stiffness calculator (SC) is provided for employing the FM to calculate the stiffness between items.

The DM builder 150 constructs a direction matrix (DM). The mapping and transform unit 148 uses the FM to map association frequency to the distance between items. The mapping unit and transform unit 148 further uses the DM to map association confidence to the color of the edge. Also, the mapping and transform unit 148 uses the DM to map association direction to the arrow of the edge.

The mapping and transform unit 148 provides the physics based system 180 with the following inputs: 1) stiffness of strings between items calculated in step 314; and 2) the vertices evenly arranged on a spherical surface. Based on these inputs, the encapsulated physics based visualization mechanism 180 is accessed through APIs 170 and employed to relax the springs between the items and to arrange the distance between items. A unit 174 is also provided to link items and to draw directed edges between items.

DAV Processing

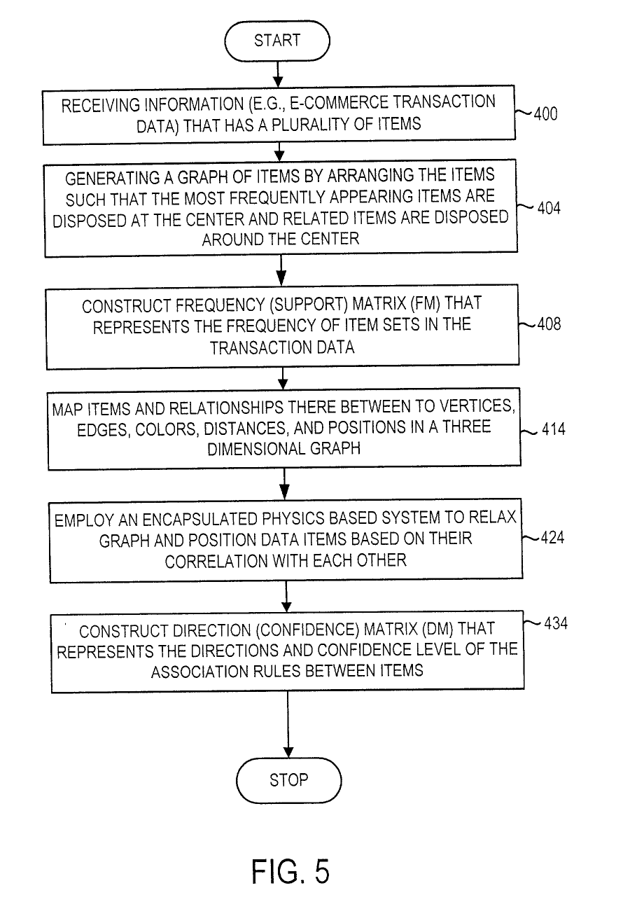

FIG. 5 is a flow chart illustrating the steps performed by the VDME 140 of FIG. 1 in accordance with one embodiment of the present invention. In step 400, information having a plurality of items is received. For example, the information can be E-commerce Internet transaction data. This step can include the sub-step of extracting the items from the transaction data, mapping each item to a vertex, and assigning a color to each vertex based on how frequently the item appears in the transactions.

In step 404, a graph of the items is generated where the most frequently appearing items are disposed at a center of a sphere and related items are disposed around the center. This step can include the sub-steps of arranging the items on a spherical surface in order to specify an initial position of each item. The initial position of each item can be randomly generated or selectively assigned as described in greater detail hereinafter.

In step 408, the FM builder 154 constructs a frequency (support) matrix (FM) that represents the frequency of the item sets in the transaction data. This step can include the sub-step of transforming a stiffness measure of a spring attached to a pair of items to a distance between the items.

In step 414, the DAV mechanism maps items and their relationships to vertices, edges, colors, distances, and positions on a three-dimensional graph. For example, a directed edge is employed to represent the direction of an association between two items. Another example is employing the color of the edge to indicate confidence level.

In step 424, the graph is relaxed by the encapsulated physics-based system 180, where after relaxation, the graph converges to a state of local minimal energy. Step 424 can includes the step of transforming stiffness of the spring to a distance in a three-dimensional sphere, where the distance between each pair of items represents the support therebetween.

In step 434, a direction (confidence) matrix that represents the confidence level and direction each association rules between items is constructed. Step 434 can include the sub-steps of receiving a user-defined minimum confidence level and only displaying items having an association with a confidence level that is in a predetermined relationship with the user-defined minimum confidence level.

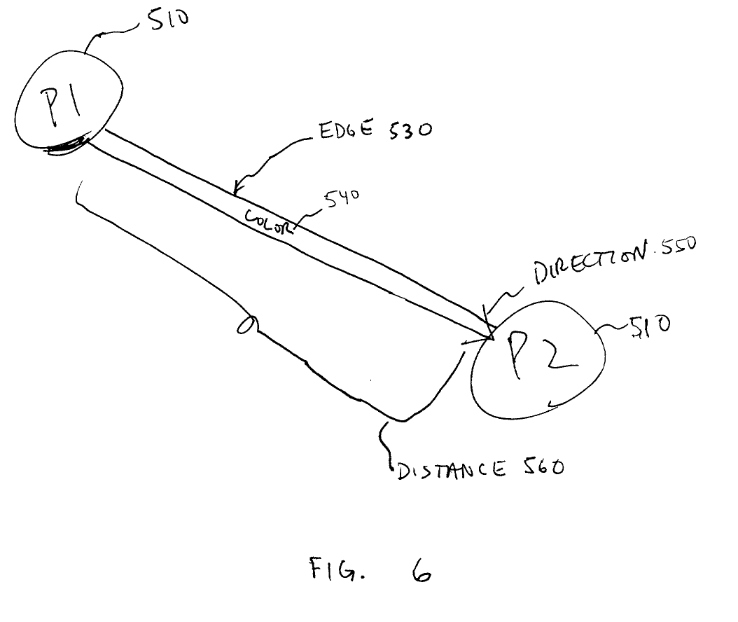

FIG. 6 illustrates an exemplary display generated by the directed association visualization program of FIG. 4. Items 510 are displayed as vertices with a specific color. Product P1 and product P2 are examples of items 510. An edge 530 connects product P1 and product P2. The edge 530 has a color 540, a direction 550, and a distance 560. It is noted that the distance 560 of the edge is related to the stiffness of a spring between the products and represents the support therebetween.

The edge 530 is also referred to as a directed edge since a direction 550 is included. For example, when the confidence level (P1=>P2) exceeds a predetermined value, but the confidence level P2=>P1 does not exceed the predetermined value, a directed edge with a single arrow pointing to P2 (as shown) is drawn on the display (i.e., P1=>P2). When the confidence level (P1=>P2) does not exceed a predetermined value, but the confidence level P2=>P1 exceeds the predetermined value, a directed edge with a single arrow pointing to P1 is drawn on the display (i.e., P1←P2). However, when the confidence level (P1=>P2) exceeds a predetermined value, and the confidence level P2=>P1 also exceeds the predetermined value, a directed edge with a two arrows is drawn on the display (i.e., P1←→P2). In one embodiment, a user can select or click on a directed edge 530 to display the confidence level values.

Component Architecture

According to one embodiment, the DAV mechanism of the present invention is implemented with a Java-based client-server model. As described earlier with reference to FIG. 3, an exemplary DAV architecture can include the following four components: an initialization component 130, a relaxation component 132, and a direction component 134. Each of the above-noted components is now described in greater detail.

Initialization Component 130

The initialization component 130 of the DAV system arranges items (e.g., items extracted from web transaction data) in a spherical surface. The items are represented as vertices, and the transaction data is described as the following:

Transactions {T1, T2 . . . , Tn}

Products {P1, . . . Pm}

Transaction Ti={P1, . . . , Pmi} i=[1 . . . n]

The initialization component 130 arranges the initial positions of items on the spherical surface in a random fashion. Alternatively, the initialization component 130 can distribute the items equally on a sphere in order to avoid random pre-clustering.

The computation of equally spaced positions is preferably based on a Poisson Disc Sampling for approximation. The Poisson Disc Sampling is a technique that is well-known to those of ordinary skill in the art and described in greater detail in A. S. Glassner: Principles of Digital Image Synthesis, Morgan Kaufmann Publishers, San Francisco, 1995, which is hereby incorporated by reference. After the computation of those positions, the most tightly related item is in the center and others are evenly distributed around. The tightness of an item is the sum of all supports to its directly adjacent items.

Relaxation Component 132

The relaxation component 132 of the DAV mechanism of the present invention constructs a frequency matrix (F), which is referred to herein as a support matrix. The frequency matrix (F) defines the stiffness of the springs attached to each pair of items. The strength of the relationship between items is represented by the stiffness of the spring. Each element contains the frequency of occurrence of the association in all transactions after normalization.

The relaxation component 132 of the DAV mechanism of the present invention transforms the spring stiffness to a distance in a three dimensional (3D) sphere after the graph has relaxed and converged to a state of local minimal energy.

Direction Component 134

The direction component 134 of the DAV mechanism of the present invention joins the antecedent of a rule with the consequence using a directed edge (e.g., an arrow) to represent the direction of the association. The confidence levels are given in a direction matrix (D), which is also referred to herein as the confidence matrix. The direction component 134 determines confidence levels by dividing the support of the item set by the support of the antecedent of the rule.

$$D = [ \begin{matrix}{d}_{11} & {d}_{12} & … & {d}_{1 n} \\ … & & & … \\ {d}_{1 i} & {d}_{2 i} & {d}_{1 i} & \\ … & & & \\ {d}_{1 n} & & … & {d}_{nn}\end{matrix} ]$$

where d(Pi, Pj)=#trans (Pi, Pj)/#trans (Pi)

dij=direction & confidence level of the association Pi→Pj

The direction component 134 of the DAV mechanism of the present invention allows a user to specify a minimum confidence level in order to identify rules with sufficient predictive power. The direction component 134 of the DAV mechanism of the present invention only draws the items with a minimum confidence value, whereas the other items are hidden. The user can easily follow the edges and directions to discover implications between items. For example, the user is able to find all antecedents that have “paper” as consequence. This visualization may help plan what the store should do to promote the sales of “paper”

The DAV mechanism of the present invention can be implemented in various applications to serve as a visualization tool for visualizing association and frequency (e.g., directed association and frequent item sets in large e-commerce transaction data). The DAV mechanism of the present invention provides a new technique for processing multi-dimensional information in a 3D space without cluttering the display. The DAV mechanism of the present invention can be employed in the e-commerce applications to analyze production recommendations, cross sale, and store shelves placement. Other application areas include customer behavior analysis applications, telecommunications fraud applications, network traffic analysis applications, user profiling applications, and text mining applications.

An example of the DAV mechanism of the present invention applied to a market basket analysis Internet application is described hereinbelow.

Market Basket Analysis Internet Application

One of the common problems electronic store managers want to solve is how to use e-customer purchase history for cross-selling and up-selling. They want to understand which products are purchased together and when to make real-time recommendations. Using the “directed association” system, we are prototyping a market basket analysis visualization application to discover product affinities and relationships from transaction data.

An e-commerce manager can navigate a DAV-generated product sales graph and answer questions on which product groups are frequently bought together, how strong the correlation is, and in which direction. From the previous example where 85% of the people who buy a printer also buy paper, this visualization

During the initialization phase, an initial layout of the graph is generated from a web log. In a sample dataset, there may be hundreds of different products that can be represented as balls, hundreds of transactions, and hundreds of edges. The color of the ball may be utilized to show how often the product appears in the transaction database over a period of time. The most tightly related product is in the center, and all others are evenly distributed around.

In a relaxation phase, the graph is relaxed with multiple iterations and reaches the local minima. The relaxation is based on the support/product affinities. The highly related products are self-organized into individual groups. The user can select a visual mining area in which to zoom in for further analysis.

In this manner, the DAV system of the present invention may be utilized by a user to visually mine large data sets (e.g., data sets containing hundreds of thousands of transactions that cover hundreds of different products) for market basket analysis. The DAV method and system of the present invention provides a useful, fast, and interactive way for users (e.g., E-commerce managers) to easily navigate through large-volume purchasing data to find product affinities for cross-selling and up-selling.

In the foregoing specification, the invention has been described with reference to specific embodiments thereof. It will, however, be evident that various modifications and changes may be made thereto without departing from the broader scope of the invention. The specification and drawings are, accordingly, to be regarded in an illustrative rather than a restrictive sense.

What is claimed is:

1. A method for visualizing information comprising the steps of:
a) receiving information having plurality of items;
b) generating a graph of the items by arranging the items on a spherical surface to specify an initial position of each item;
c) constructing a frequency matrix for defining a stiffness measure of a spring attached to each pair of items;
d) relaxing the graph; wherein after relaxation the graph converges to a state of local minimal energy; wherein the distance between a pair of items represents the frequency of the item set in the transaction data; and
e) employing a directed edge to represent the association confidence levels and association directions between the items in the transaction data.

2. The method of claim 1 further comprising the steps of:
f) generating a confidence matrix for defining the confidence level of each association.

3. The method of claim 2 further comprising the steps of:
g) receiving a user-defined minimum confidence level;
h) displaying items having an association with a confidence level that is in a predetermined relationship with the user-defined minimum confidence level.

4. The method of claim 1 wherein the step of receiving a plurality of items comprises the steps of:
a_{—}1) receiving Internet transaction data; wherein the transaction data is described as follows
Transactions {T1, T2, . . . , Tn}
Products {P1, . . . Pm}
Transaction Ti={P1, . . . , Pmi} i=[1 . . . n]; and
a_{—}2) extracting items from the Internet transaction data.

5. The method of claim 1 wherein the information includes a plurality of transactions, where each transaction includes one or more items; and wherein the step of generating a graph of the items by arranging the items on a spherical surface to specify an initial position of each item includes the step of
b_{—}1) organizing the items based on how frequently the items appear in transactions; and
b_{—}2) specifying the initial position of each item in one of a random fashion and a predetermined fashion.

6. The method of claim 5 wherein the step of specifying the initial position of each item in one of a random fashion and a predetermined fashion includes the step of distributing the items equally on a spherical surface; wherein tightness is a sum of all supports from a current item to directly adjacent items; and wherein more tightly related items are disposed in the center of the sphere and the less tightly related items are evenly distributed around the center.

7. The method of claim 6 wherein the step of distributing the items equally on a spherical surface includes distributing the items equally on a spherical surface by employing a Poisson Disc Sampling.

8. The method of claim 1 wherein the frequency matrix includes a plurality of elements, wherein each element includes the frequency of occurrence of the association in all transactions after normalization.

9. The method of claim 1 further comprising the step of:
transforming stiffness of the spring to a distance in a three-dimensional sphere; wherein the distance between each pair of items represents the support therebetween.

10. The method of claim 1 wherein employing a directed edge to represent the direction of an association between two items further includes the step of:
employing color of the edge to indicate confidence level.

11. A system for use in visualizing information comprising:
a) a source of transaction data having items; and
b) a directed association mechanism coupled to the source of transaction data for receiving transaction data, mapping items and relationships between items to vertices, edges, and positions on a visual spherical surface, and for generating and displaying a self-organized graph, wherein the distance between each pair of items represents support, a directed edge represents the direction of the association, and the color of the edge is used to represent the confidence level.

12. The system of claim 11 wherein the directed association mechanism further comprises:
an initialization component for receiving items and arranging the items into an initial position on a spherical surface to generate a graph;
a relaxation component for constructing a frequency matrix that defines a stiffness measure of a spring attached to each pair of items and for relaxing the graph; wherein after relaxation the graph converges to a state of local minimal energy; and
a direction component for determining edge direction and edge color; wherein the support is the frequency of the item set in the transaction data.

13. The system of claim 12 wherein the relaxation component encapsulates a mass-spring engine for relaxing the graph and enabling the graph to converge to a state of local minimal energy.

14. The system of claim 12 wherein the direction component generates a confidence matrix for defining the direction and confidence level of the association rules.

15. The system of claim 11 wherein the source of transaction data is an electronic commerce web site, the items are products for sale, and the transaction data is transaction data from an electronic commerce application; and
wherein the system is utilized to visually associate product affinities and relationships therebetween.

16. The system of claim 11 wherein the system is utilized in a market basket analysis application.

17. The system of claim 11 wherein the system is utilized in a telecommunications fraud application.

18. The system of claim 11 wherein the system is utilized in a network traffic analysis application.

19. The system of claim 11 wherein the system is utilized in a text mining application.

20. The system of claim 11 wherein the system is utilized in a user profiling application.
